(19) United States
(12) Patent Application Publication
(10) Pub. No.: US 2024/0404741 A1
(43) Pub. Date: Dec. 5, 2024

(54) COMMON MODE FILTER

(71) Applicant: CHILISIN ELECTRONICS CORP., TAOYUAN CITY (TW)

(72) Inventors: HUNG-CHIH LIANG, TAOYUAN CITY (TW); PIN-YU CHEN, TAOYUAN CITY (TW); HANG-CHUN LU, TAOYUAN CITY (TW); YA-WEN YANG, TAOYUAN CITY (TW); SHIH-KAI HUANG, TAOYUAN CITY (TW); YU-TING HSU, TAOYUAN CITY (TW); WEI-ZHI HUANG, TAOYUAN CITY (TW)

(21) Appl. No.: 18/502,087

(22) Filed: Nov. 6, 2023

(30) Foreign Application Priority Data
Jun. 1, 2023 (TW) 112120430

(51) Int. Cl. H01F 17/04; H01F 27/29

(52) U.S. Cl. CPC H01F 17/045; H01F 27/292; H01F 2017/0093

(57) ABSTRACT

A common mode filter includes a first iron core, a second iron core, a first coil, and a second coil. The first iron core includes two first electrode portions and two second electrode portions. The second iron core is disposed above the first iron core, and the first iron core and the second iron core are adhered to each other. All surfaces of the second iron core are coated with an insulating layer. The first coil is wound around the first iron core and the second iron core. The second coil is wound around the first iron core and the second iron core.

### CROSS-REFERENCE TO RELATED PATENT APPLICATION

This application claims the benefit of priority to Taiwan Patent Application No. 112120430, filed on Jun. 1, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a common mode filter, and more particularly to a common mode filter made of composite materials.

### BACKGROUND OF THE DISCLOSURE

A common mode filter, or a common mode filter inductor, filters out common mode noise signals. Generally, the common mode filter is made from a single material, such as Ni—Zn based ferrite. The Ni—Zn based ferrite has a good suppression effect on high-frequency noise signals, but a poor suppression effect on low-medium frequency noise signals, which results in limitations in some applications. In addition, another common mode filter is made of composite materials. However, in the common mode filter made of composite materials, the material used to suppress low-medium frequency noise signals has poor insulation coefficients. Therefore, such a common mode filter made of composite materials is prone to short-circuit and burnout during operation.

Therefore, how to overcome the above-mentioned problem through an improvement in structural design has become an important issue to be addressed in the related art.

### SUMMARY OF THE DISCLOSURE

In response to the above-referenced technical inadequacies, the present disclosure provides a common mode filter.

In order to solve the above-mentioned problems, one of the technical aspects adopted by the present disclosure is to provide a common mode filter, which includes a first iron core, a second iron core, a first coil, and a second coil. The first iron core includes two first electrode portions and two second electrode portions. The second iron core is disposed above the first iron core, and the first iron core and the second iron core are adhered to each other. All surfaces of the second iron core are coated with an insulating layer. The first coil is wound around the first iron core and the second iron core. The second coil is wound around the first iron core and the second iron core.

Therefore, in the common mode filter provided by the present disclosure, by virtue of “all surfaces of the second iron core being coated with an insulating layer,” the insulation resistance of the second iron core can be increased to reduce a risk of short circuit of the common mode filter.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a first schematic perspective view of a common mode filter according to the present disclosure;

FIG. 2 is a second schematic perspective view of the common mode filter according to the present disclosure;

FIG. 3 is a schematic view of the common mode filter being disposed on a circuit board according to the present disclosure;

FIG. 4 is a schematic exploded view of the common mode filter according to the present disclosure; and

FIG. 5 is a schematic side view of the common mode filter according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### Embodiment

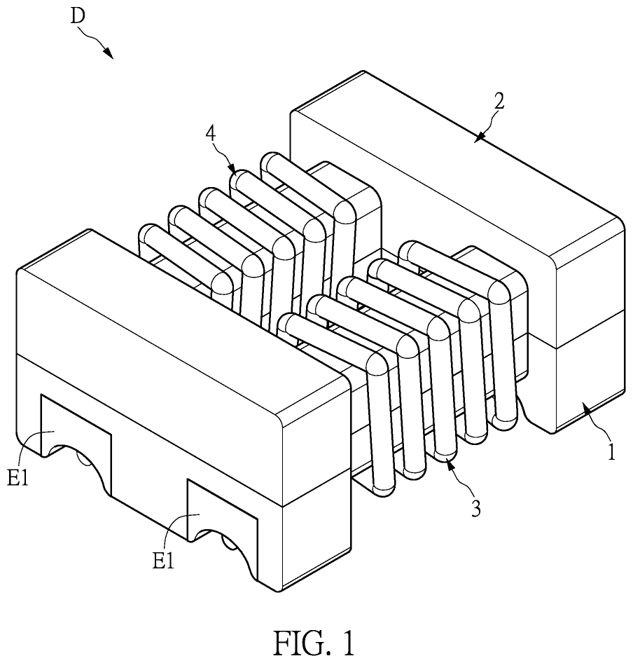

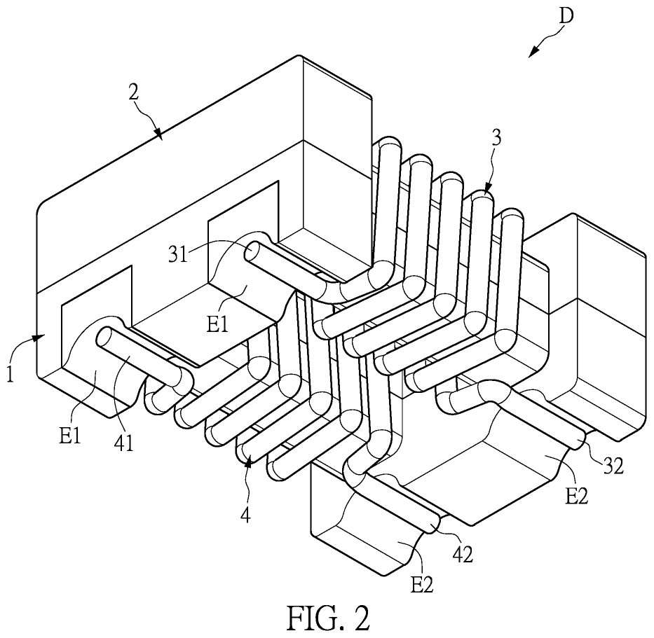

Referring to FIG. 1 and FIG. 2, FIG. 1 is a first schematic perspective view of a common mode filter according to the present disclosure, and FIG. 2 is a second schematic perspective view of the common mode filter according to the present disclosure. The present disclosure provides a common mode filter D, which includes a first iron core 1, a second iron core 2, a first coil 3, and a second coil 4. The first iron core 1 and the second iron core 2 are stacked with each other. Specifically, the second iron core 2 is disposed above the first iron core 1, and the first iron core 1 and the second iron core 2 are adhered to each other. The first coil 3 and the second coil 4 are wound around the first iron core 1 and the second iron core 2. In addition, for example, a ratio of a volume of the first iron core 1 and a volume of the second iron core 2 is 1 to 1, but the present disclosure is not limited thereto.

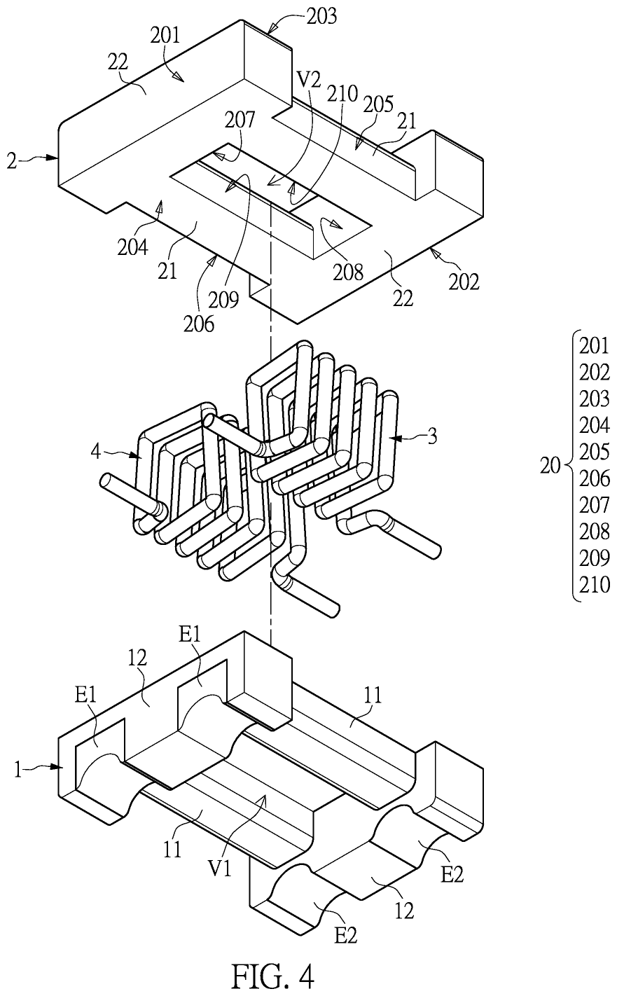

Referring to FIG. 2 and FIG. 4, FIG. 4 is a schematic exploded view of the common mode filter according to the present disclosure. The first iron core 1 includes two first longitudinal columns 11 and two first transverse columns 12. The two first transverse columns 12 are connected between the two first longitudinal columns 11, and the two first longitudinal columns 11 and the two first transverse columns 12 form a rectangular shape that has an opening V1. Similarly, the second iron core 2 includes two second longitudinal columns 21 and two second transverse columns 22. The two second transverse columns 22 are connected between the two second longitudinal columns 21, and the two second longitudinal columns 21 and the two second transverse columns 22 form a rectangular shape that has an opening V2.

Moreover, when the first iron core 1 and the second iron core 2 are stacked with each other, the two first longitudinal columns 11 respectively correspond to the two second longitudinal columns 21, and the two first transverse columns 12 respectively correspond to the two second transverse columns 22. The first coil 3 is wound around one of the two first longitudinal columns 11 and a corresponding one of the two second longitudinal columns 21, and the second coil 4 is wound around another one of the two first longitudinal columns 11 and a corresponding one of the two second longitudinal columns 21. In other words, each of the first coil 3 and the second coil 4 is wound around all of the iron cores simultaneously.

The first iron core 1 includes two first electrode portions E1 and two second electrode portions E2. The two first electrode portions E1 are disposed on a bottom of one of the two first transverse columns 12, and the two second electrode portions E2 are disposed on a bottom of another one of the two first transverse columns 12. For example, the first electrode portions E1 and the second electrode portions E2 are formed by electroplating. In order to avoid electrical conduction between the electrode portions and the first iron core 1, the first iron core 1 is made of a material with a high insulation coefficient. Preferably, a material of the first iron core 1 includes Ni—Zn, and an impedance of the first iron core 1 is greater than 1 M ohm.

As shown FIG. 2 and FIG. 4, the two first electrode portions E1 and the two second electrode portions E2 have arc-shaped concave surfaces. The first coil 3 has a first end 31 and a second end 32. The first end 31 extends into a recessed area formed by the concave surface of one of the first electrode portions E1 and is connected to one of the first electrode portions E1, and the second end 32 extends into a recessed area formed by the concave surface of one of the second electrode portions E2 and is connected to one of the second electrode portions E2. Similarly, the second coil 4 has a first end 41 and a second end 42. The first end 41 extends into a recessed area formed by the concave surface of another one of the first electrode portions E1 and is connected to another one of the first electrode portions E1, and the second end 42 extends into a recessed area formed by the concave surface of another one of the second electrode portions E2 and is connected to another one of the second electrode portions E2.

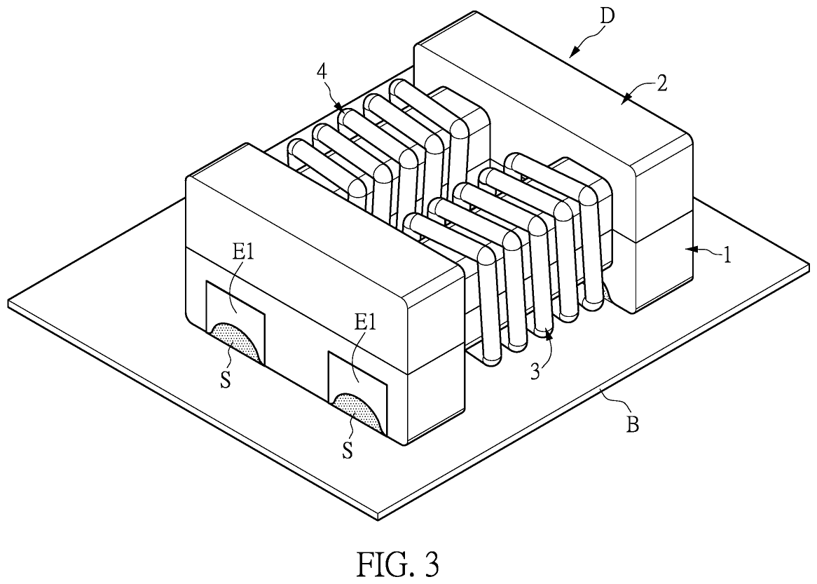

Referring to FIG. 3, FIG. 3 is a schematic view of the common mode filter being disposed on a circuit board according to the present disclosure. The common mode filter D is soldered to a circuit board B with solder pastes S through the first electrode portions E1 and the second electrode portions E2. As shown in FIG. 3, the solder pastes S can be filled in the recessed areas of the first electrode portions E1 and the second electrode portions E2 and cover the first end 31 and the second end 32 of the first coil 3, and cover the first end 41 and the second end 42 of the second coil 4. Therefore, the first coil 3 and the second coil 4 can be electrically connected to the circuit board B. When the common mode filter D operates, the two sets of coils (the first coil 3 and the second coil 4) conduct with current and form a high voltage side (high side) and a low voltage side (low side), respectively.

In the present disclosure, the impedance of the first iron core 1 is greater than an impedance of the second iron core 2. Preferably, the impedance of the first iron core 1 is greater than 1 M ohm, and the impedance of the second iron core 2 is less than 0.1 M ohm. In addition, the first iron core 1 and the second iron core 2 are magnetic cores made of a ferrite material having magnetic properties. For example, a material of the first iron core 1 includes Ni—Zn, and a material of the second iron core 2 includes Mn—Zn, amorphous alloy or nanocrystalline. Therefore, the common mode filter D of the present disclosure can suppress high-frequency noise signals through the high-impedance first iron core 1 and suppress low-medium frequency noise signals through the low-impedance second iron core 2.

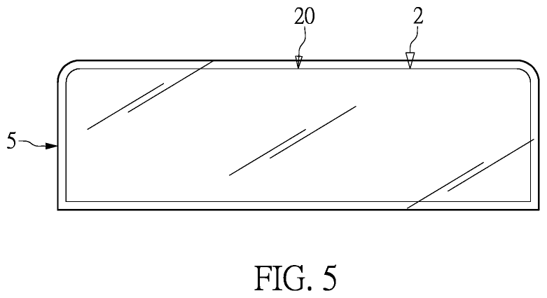

Referring to FIG. 5, FIG. 5 is a schematic side view of the common mode filter according to the present disclosure. A surface 20 of the second iron core 2 is coated with an insulating layer 5. Preferably, a thickness of the insulating layer 5 ranges from 0.05 mm to 1 mm. As mentioned above, the common mode filter D can suppress low-medium frequency noise signals through the low-impedance second iron core 2. However, the second iron core 2 has a low insulation coefficient. When a voltage difference between the high side and the low side is too large, a short circuit may easily occur and the filter may burn out. Therefore, in the present disclosure, an insulation strength of the second iron core 2 can be improved by coating the insulating layer 5 on the surface 20 of the second iron core 2, so as to reduce the risk of short circuit of the common mode filter D.

A material of the insulating layer includes high polymer, such as polyimide resin and epoxy resin, but the present disclosure is not limited in thereto. In addition, it should be noted that the insulating layer 5 is coated on all surfaces of the second iron core 2. Since FIG. 5 only shows the second iron core 2 from one perspective, not all surfaces of the second iron core 2 coated with the insulating layer 5 can be seen. As shown in FIG. 4, the surface 20 of the second iron core 2 includes a first surface 201, a second surface 202, a third surface 203, a fourth surface 204, a fifth surface 205, a sixth surface 206, a seventh surface 207, an eighth surface 208, a ninth surface 209, and a tenth surface 210, and the insulating layer 5 is completely coated on these surfaces. It is worth mentioning that the fourth surface 204 is a connecting surface of the second iron core 2, and the second iron core 2 is adhered to the first iron core 1 through the connecting surface. In other words, the insulating layer 5 completely covers the second iron core 2.

In addition, it should be noted that the common mode filter D of the present disclosure includes two iron cores respectively composed of two materials, but the present disclosure is not limited thereto. In other embodiments of the present disclosure, the common mode filter D can also be composed of three or more iron cores made of three or more materials. The iron core with high insulation strength is placed on the lower layer, and the iron core with low insulation strength is placed on the upper layer. Moreover, all surfaces of the iron core with low insulation strength on the upper layer also need to be coated with insulating materials.

### Beneficial Effects of the Embodiment

In conclusion, in the common mode filter provided by the present disclosure, by virtue of “all surfaces (i.e., the first surface 201 to the tenth surface 210) of the second iron core 2 being coated with an insulating layer 5,” the insulation resistance of the second iron core 2 can be increased to reduce a risk of short circuit of the common mode filter D.

The common mode filter D of the present disclosure can suppress high-frequency noise signals through the high-impedance first iron core 1 and suppress low-medium frequency noise signals through the low-impedance second iron core 2. However, the second iron core 2 has a low insulation coefficient. When a voltage difference between the high side and the low side is too large, a short circuit may easily occur and the filter may burn out. Therefore, in the present disclosure, an insulation strength of the second iron core 2 can be improved by coating the insulating layer 5 with a thickness ranging from 0.5 mm to 1 mm on the surface 20 of the second iron core 2, so as to increase insulation impedance of the second iron core 2 and reduce the risk of short circuit of the common mode filter D.

Before the surface 20 of the second iron core 2 is coated with the insulating layer 5, the impedance of the second iron core 2 is less than 0.1 M ohm. After the surface 20 of the second iron core 2 is coated with the insulating layer 5, the impedance of the second iron core 2 is greater than 1 M ohm. Therefore, the common mode filter D of the present disclosure can not only suppress high-frequency and low-medium frequency noise signals through composite materials, but improve the insulation strength of the second iron core 2 by coating all surfaces with insulating materials, thereby reducing the risk of short circuit.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A common mode filter, comprising:
a first iron core including two first electrode portions and two second electrode portions;
a second iron core disposed above the first iron core, wherein the first iron core and the second iron core are adhered to each other, and all surfaces of the second iron core are coated with an insulating layer;
a first coil wound around the first iron core and the second iron core; and
a second coil wound around the first iron core and the second iron core.

2. The common mode filter according to claim 1, wherein the first iron core includes two first longitudinal columns and two first transverse columns that are connected to the two first longitudinal columns, the second iron core includes two second longitudinal columns and two second transverse columns that are connected to the two second longitudinal columns, the two first electrode portions are disposed on a bottom of one of the two first transverse columns, and the two second electrode portions are disposed on a bottom of another one of the two first transverse columns.

3. The common mode filter according to claim 2, wherein the two first longitudinal columns respectively correspond to the two second longitudinal columns, the two first transverse columns respectively correspond to the two second transverse columns, the first coil is wound around one of the two first longitudinal columns and a corresponding one of the two second longitudinal columns, and the second coil is wound around another one of the two first longitudinal columns and a corresponding one of the two second longitudinal columns.

4. The common mode filter according to claim 2, wherein the two first electrode portions and the two second electrode portions have arc-shaped concave surfaces.

5. The common mode filter according to claim 4, wherein one end of the first coil is connected to one of the two first electrode portions, another end of the first coil is connected to one of the two second electrode portions, one end of the second coil is connected to another one of the two first electrode portions, and another end of the second coil is connected to another one of the two second electrode portions.

6. The common mode filter according to claim 1, wherein an impedance of the first iron core is greater than an impedance of the second iron core.

7. The common mode filter according to claim 6, wherein the impedance of the first iron core is greater than 1 M ohm, and the impedance of the second iron core is less than 0.1 M ohm.

8. The common mode filter according to claim 1, wherein a material of the first iron core includes Ni—Zn, and a material of the second iron core includes Mn—Zn, amorphous alloy or nanocrystalline.

9. The common mode filter according to claim 1, wherein a material of the insulating layer includes high polymer.

10. The common mode filter according to claim 1, wherein a thickness of the insulating layer ranges from 0.05 mm to 1 mm.

11. The common mode filter according to claim 1, wherein an impedance of the second iron core after being coated with the insulating layer is greater than 1 M ohm.

12. The common mode filter according to claim 1, wherein a ratio of a volume of the first iron core and a volume of the second iron core is 1 to 1.
